(19) United States
(12) Patent Application Publication
(10) Pub. No.: US 2009/0198747 A1
(43) Pub. Date: Aug. 6, 2009

(54) Memory Card Reader Device for Recovering Memory Card

(75) Inventors: Hyun Jeong Kim, Jeonju Jeonbuk (KR); Eui Bung Jeoung, Jeonju Jeonbuk (KR)

Correspondence Address: PATENT LAW GROUP LLP, 2635 NORTH FIRST STREET, SUITE 223, SAN JOSE, CA, 95134, US

(73) Assignee: NTFS CO., LTD, Jeonbuk (KR)

(21) Appl. No.: 12/304,461

(22) PCT Filed: Sep. 28, 2007
(86) PCT No.: PCT/KR2007/004769

§ 371 Date: Dec. 11, 2008

(30) Foreign Application Priority Data
Sep. 30, 2006 (KR) 10-2006-0096659
Sep. 30, 2006 (KR) 10-2006-0096660
Sep. 27, 2007 (KR) 10-2007-0097563

(51) Int. Cl. G06F 17/30; G06F 12/00

(52) U.S. Cl. 707/202; 711/115; 707/203; 711/E12.001; 707/E17.01

(57) ABSTRACT

Disclosed is a memory card reader recovering memory card. The memory card reader recovering memory card according to an embodiment of the present invention may comprise a first interfacing unit interfacing with a memory card, a first storing unit storing a recovery program for recovering any deleted or impaired data in the memory card, a control unit executing the recovery program for the deleted or impaired data at a recovery mode and a display unit displaying a file list of both data stored in the memory card and the data recovered on a display screen.

### TECHNICAL FIELD

The present invention relates to memory card reader, more particularly, to a memory card reader recovering a memory card performing either read/write or recovery of the memory card after storing a recovery program, based on an output signal selectively outputted according to manipulation of a switch. Moreover, the present invention relates to a memory card reader in which displays a file list stored therein on a display screen, recovers any damaged data through the recovery program, confirms data file names recovered on the display screen, and secures a self-storing space.

### BACKGROUND ART

IT (Information Technology) market has been developed toward speedy development of articles having those functions as small sized, higher memory and multimedia. In that regard, many memory cards have been used. The memory card, as one of portable storing devices, is a data storing device widely using in various digital electronic devices such as PC, PDA (Personal Digital Assistants), Digital camera and MP3 Player, etc.

Memory card readers have been also used for replaying and writing by connecting the memory card to outer terminals.

Meanwhile, it is necessary for the memory card to recover, since data stored in the memory card may be deleted, modified or impaired due to user mistakes or mechanical defects, when data is stored in the memory card by connecting to outer terminals or incorporating into terminals.

### DISCLOSURE OF INVENTION

### Technical Problem

In case that data stored in memory card is deleted or is required to recover, the data was recovered by installing a recovery program into an outer terminal. However, such a recovery of memory card by using the outer terminal in which a separate recovery program is installed has problems in that there is troublesome in installing the recovery program to a separate outer terminal, and the recovery program may illegally be copied.

Therefore, it is required to develop a portable device for both immediately confirming and recovering image data either impaired or deleted, in memory cards such as SD (secure digital) card, MMC card or CF card mainly using in digital cameras.

### Technical Solution

The technical task of the present invention provides preventing illegal copy of recovery program and recovering data in the memory card to be recovered, by incorporating recovery program in a memory card reader.

The other technical task of the present invention provides a memory card reader having complex functions in which performs either read/write of data or recovery by using the recovery program in the memory card, in response to either the read/write signal or a recovery signal selectively outputted by a switch in the memory card reader, by incorporating the switch and the recovery program in a memory card reader.

It also provides enhancement of recovering capability by receiving updated information through outer terminals and performing update of the recovery program in the memory card reader.

The still another technical task of the present invention provides a memory card reader may confirm recovery results of deleted/impaired data on display screen and store necessary files without using external terminals or recovery programs, by installing recovery program.

A memory card reader recovering memory card according to an exemplary embodiment of the present invention may comprise an interfacing unit interfacing a memory card to be recovered, a storing unit storing a recovery program for recovering the memory card, a reader connector both transmitting and receiving data by connecting to a reader port of an outer terminal, and a control unit loading the recovery program stored in the storing unit, recovering data in the memory card received through the interfacing unit and outputting the data recovered to the reader connector.

A memory card reader recovering memory card according to another exemplary embodiment of the present invention may comprise an interfacing unit interfacing a memory card, a switch selectively outputting a read/write signal or a recovery signal for either read/write or recovery of the memory card, a storing unit storing a recovery program for recovering the memory card in response to the recovery signal of the switch, a reader connector both transmitting and receiving data by connecting to a reader port of an outer terminal and a control unit both sending data either read/written or recovered to the reader connector after performing either read/write of data or recovery by using the recovery program, into the memory card, in response to either the read/write signal or a recovery signal selectively outputted, and storing data outputted from the outer terminal into the memory card through the interfacing unit.

Moreover, the storing unit is updated by receiving an updated recovery program from the outer terminal.

A memory card reader recovering memory card according to still another exemplary embodiment of the present invention may comprise a first interfacing unit interfacing with a memory card, a first storing unit storing a recovery program for recovering any deleted or impaired data in the memory card, a control unit executing the recovery program for the deleted or impaired data at a recovery mode and a display unit displaying a file list of both data stored in the memory card and the data recovered on a display screen.

The memory card reader further comprises a second interfacing unit providing user interface for the file list displayed on the display screen.

The display unit provides preview function for any selected files of the file list.

The recovery program is compatible to a plurality of file systems having various versions.

The first interfacing unit provides interfacing for a plurality of various memory cards.

The control unit stores files recovered in other memory card connecting to the first interfacing unit by mentioning other file names than original ones.

The first interfacing unit provides interfacing for SD (Secure Digital), MMC (Multimedia Card) and CF (Compact Flash) memory cards.

The memory card reader further comprises a second storing unit, and the control unit stores files recovered in the second storing unit by mentioning other file names than original ones.

The memory card reader further comprises a power supplying unit making powers necessary operation of the memory card reader itself.

The memory card reader further comprises a third interfacing unit providing interfacing with an outer terminal.

The memory card reader further comprises a switch for selecting whether entering to the recovery mode.

### ADVANTAGEOUS EFFECTS

The present invention recovers a memory card to be recovered, by incorporating a recovery program in the memory card reader, so that it may lessen any troublesome works as separate recovery through external terminals installment of recovery program to a separate terminal, and be easily utilized to users who are unskilled in computer and electronic equipments.

Moreover, it has another merit in that it would be difficult to copy the recovery program illegally by both incorporating and using a recovery program in the memory card reader other than general typed personal computer in which illegal copy is more easily played.

It also prevents illegal copy of recovery program, by incorporating the recovery program therein.

It also provides enhancement of recovering capability by receiving updated information through outer terminals and performing update of the recovery program in the memory card reader.

Finally, it also provides a convenient Graphic User Interface (GUI) such as select files for data both stored in a memory card and recovered on display screen, as well as recovering data without external terminals by incorporating recovery program. Moreover, it stores data recovered without connecting to external terminals such as computers by securing a self-storing space, so that it may be used as a portable storage device.

### BRIEF DESCRIPTION OF THE DRAWINGS

The above and other features and advantages of the present invention will become more apparent by describing in detailed example embodiments thereof with reference to the accompanying figures, in which:

FIG. 1 is a configuration of a memory card reader recovering memory card according to an exemplary embodiment of the present invention.

FIG. 2 is a configuration of a memory card reader recovering data according to other exemplary embodiment of the present invention.

FIG. 3 is a block diagram partially illustrating a memory card reader according to still another exemplary embodiment of the present invention.

FIG. 4 is a block diagram illustrating the function of a control unit of FIG. 3.

### BEST MODE FOR CARRYING OUT THE INVENTION

In order to sufficiently understand the present invention, the benefits for the operations of the present invention, and the purpose of achievement for the embodiments of the present invention, it will be referred to the corresponding drawings and the contents of the corresponding drawings.

Preferable embodiments of the invention are described below with reference to the corresponding drawings. Throughout the drawings, reference numbers indicate identical elements, components, or steps.

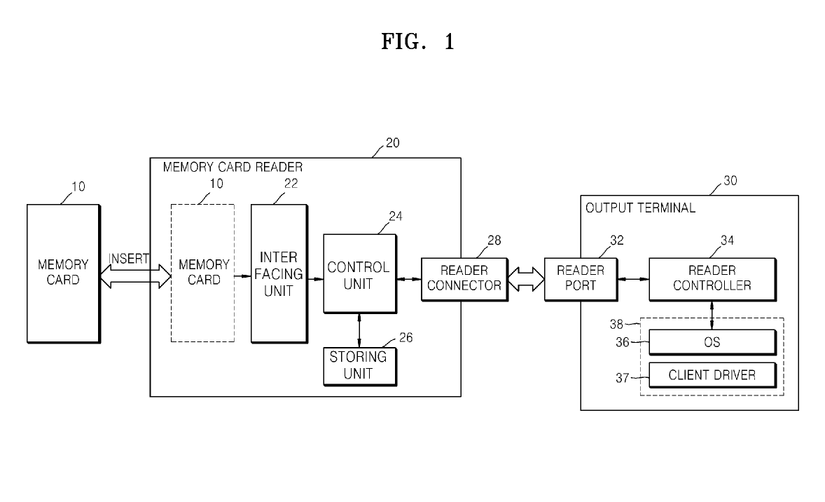

FIG. 1 is a configuration of a memory card reader recovering memory card according to an exemplary embodiment of the present invention.

Referring to FIG. 1, a memory card reader 20 recovering memory card according to an exemplary embodiment of the present invention may comprise an interfacing unit 22, a control unit 24, a storing unit 26 and a reader connector 28.

The interfacing unit 22 may connect a memory card 10 to the control unit 24 after acknowledging the memory card 10 for recovering and interfacing the memory card 10 by model.

The interfacing unit 22 installed in the memory card reader 20 may interface any kinds of memory card inserted to the memory card reader 20 by model of the memory card.

The control unit 24 may acknowledge the memory card 10 through the interfacing unit 10 and restore data in the memory card 10 by using a recovery program in a storing unit 26 illustrated below. In other words, after the control unit 24 acknowledges the memory card 10, the recovery program stored in the storing unit 26 is loading to the control unit 24 so that data in the memory card 10 may be recovered.

Thus, the present invention has a merit to more easily recover memory card, by recovering data in the memory card 10 while incorporating a recovery program in the memory card reader 20, and by recovering data in the memory card 10 while using the memory card reader 20 incorporating the recovery program, so that it may lessen any troublesome works as installment of recovery program to a separate terminal and be easily utilized to users who are unskilled in computer and electronic equipments. Moreover, it has another merit in that it would be difficult to copy the recovery program illegally by both incorporating and using a recovery program in the memory card reader 20 other than general typed personal computer in which illegal copy is more easily played.

Meanwhile, the control unit 24 may update a recovery program stored in the storing unit 26 by receiving the recovery program updated or various updated information from outside.

The storing unit 26 may be selectively implemented with either non-volatile memory like ROM (Read Only Memory) or volatile memory like RAM (Random Access memory), and store a recovery program or various information.

In case that the storing unit 26 stores a recovery program or various information as ROM, the memory card 10 may be restored by loading the recovery program in less time by control of the control unit 24.

In case that the storing unit 26 stores a recovery program or various information as RAM, it may update the recovery program or various information by receiving information updated from outside.

Meanwhile, the reader connector 28 may send an output of the control unit 24 to an outer terminal 30 after receiving the output of the control unit 24, or send information of the outer terminal 30 to the control unit 24 after receiving the information of the outer terminal 30, by connecting itself to a reader port 32 of the outer terminal 30 illustrated below.

The reader connector 28 may send data recovered by the control unit 24 to the outer terminal 30 or information received from the outer terminal 30 to the control unit 24.

Generally, the outer terminal 30 may be electronic devices such as Personal computer, PDA, TV or DVD, etc. which are all possible to both replaying and writing. The outer terminal 30 may comprise a reader port 32, a reader controller 34 and a terminal storing unit 38.

The reader port 32 may be either embedded or external as the memory card reader 20 is installed to the outer terminal 30 by either embedded or external type. Namely, in case that the memory card reader 20 is embedded in the outer terminal 30, the reader port 32 may be connected to the reader connector 28 by an embedded type. And, in case that the memory card reader 20 is installed in the outer terminal 30 in an external type, the reader port 32 may be connected to the reader connector 28 in an external type. The reader port 32 may transmit or receive data of both the outer terminal 30 and the memory card reader 20 by connecting itself to the reader connector 28.

The outer terminal 30 may be implemented in USB (Universal Serial Bus) Port (Not shown) other than the reader port 32. The outer terminal 30 may transmit or receive data to/from the memory card reader 20 by connecting the USB port to the reader connector 28.

Meanwhile, the reader controller 34 is a controller controlling transmission/receipt of data between the outer terminal and peripheral devices by sensing the peripheral devices connected to the reader port 32. According to the present invention, the reader controller 34 may acknowledge and control the memory card reader 20.

The terminal storing unit 39 may be implemented in hard disk. It may have internally OS (operating system) and a client driver 37. The client driver 37 is provided by a manufacturing company of the memory card reader 20.

The outer terminal 30 may comprise a microprocessor (not shown). And, the microprocessor may control the outer terminal 30 on the whole according to both the OS and the client driver 37 stored in the terminal storing unit 38.

Especially, the outer terminal 30 may send a recovery program updated to the memory card reader 20 through the reader port 32 connected to the reader connector 28 by either connecting itself to homepage of the manufacturing company of the memory card reader 20 through outside telecommunication network or receiving the recovery program updated from relevant storage devices. The control unit 24 of the memory card reader may update the recovery program previously stored in the storing unit 26 of the memory card reader after receiving the recovery program updated through the reader connector 28.

Therefore, the present invention may more effectively recover the memory card 10 in less time by updating the recovery program in the memory card reader 20 through the outer terminal 30.

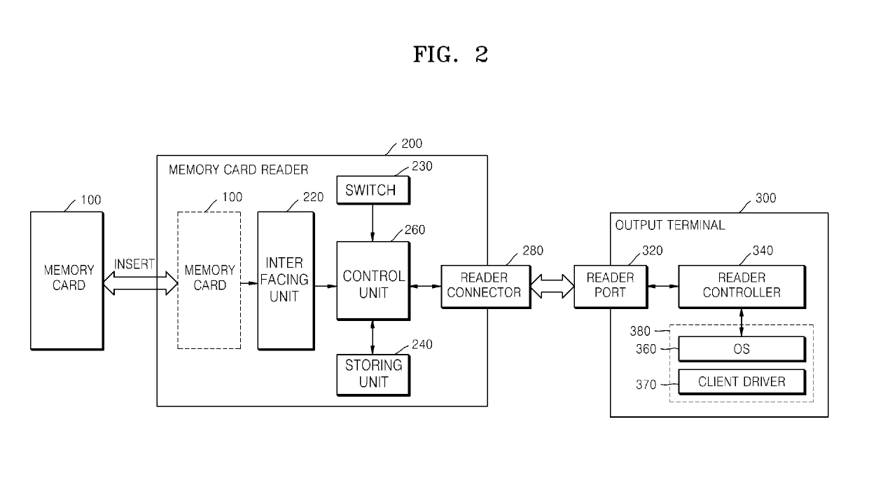

FIG. 2 is a configuration of a memory card reader recovering data according to other exemplary embodiment of the present invention.

Referring to FIG. 2, a memory card reader 200 according to other exemplary embodiment of the present invention may comprise an interfacing unit 220, a switch 230, a storing unit 240, a control unit 240 and a reader connector 280.

The interfacing unit 220 may connect a memory card 100 to the control unit 260 after acknowledging the memory card 100 and interfacing the memory card 100 by model.

The memory card 100 to be inserted in the memory card reader 200 may be selectively inserted by users, as a memory card for either read/write or data recovery.

The switch 230 may selectively output either a read/write signal for read/write of the memory card, as a general function of the memory card reader 200, or a recovery signal for recovering the memory card to be recovered, according to user s selection.

Namely, the memory card reader 200 of the other exemplary embodiment of the present invention may be separately operated to either read/write mode or recovery mode by either the read/write signal or the recovery signal outputted by the switch 23.

More specifically, when the switch 230 does not operate, it outputs the read/write signal so as to perform read/write function of a general function of memory card reader. However, when the switch 230 operates, it outputs the recovery signal so as to recover data in the memory card 100.

Thus, the memory card reader 200 may be used as a complex memory card reader having both a general function of memory card reader and a data recovery function, by selectively selecting the functions through the switch 230.

Meanwhile, the storing unit 240 may be implemented with either non-volatile memory like ROM or volatile memory like RAM (Random Access memory), and store the recovery program for recovering data in the memory card 100 according to the recovery mode of the memory card reader 200, and various information for recovering memory card. The recovery program stored may be loaded to the control unit 260 by the recovery signal of the switch 230.

In case that the storing unit 240 is implemented in non-volatile memory like ROM, the recovery program may be updated as a firmware by external devices.

The control unit 260 may acknowledge the memory card 100 through the interfacing unit 220 and perform either read/write or recovery of the memory card 100 in response to either the read/write signal or recovery signal outputted from the switch 230.

More specifically, the control unit 260 may send data to an outer terminal 300 illustrated below through the reader connector 280 after performing reading of the data in the memory card 100 in case that the switch 230 outputs the read/write signal, or perform writing into the memory card 100 after receiving data through the reader connector 280 from the outer terminal 300. Namely, the control unit 260 may perform the general function of memory card reader only when the switch 230 outputs the read/write signal.

Moreover, the control unit 260 may recover data in the memory card 100 to be recovered by loading the recovery program stored in the storing unit 240.

Thus, the present invention has a merit to more easily recover memory card, by recovering the memory card 100 by using a recovery program stored in the storing unit 240, so that it may lessen any troublesome works as installment of recovery program to a separate terminal and be easily utilized to users who are unskilled in computer and electronic equipments.

Moreover, it has another merit in that it would be difficult to copy the recovery program illegally by incorporating a recovery program in the memory card reader 200 other than a separate terminal.

And, the control unit 260 may update the recovery program stored in the storing unit 240 by receiving any update information of the recovery program received from the outer terminal 300.

Meanwhile, the reader connector 280 may send an output of the control unit 24 to an outer terminal 300 after receiving the output of the control unit 240, or send information of the outer terminal 300 to the control unit 240 after receiving the information of the outer terminal 30, by connecting itself to a reader port 320 of the outer terminal illustrated below.

Generally, the outer terminal 300 may be electronic devices such as Personal computer, PDA, TV or DVD, etc. which are all possible to both replaying and writing. The outer terminal 300 may comprise a reader port 320, a reader controller 340 and a terminal storing unit 380.

The reader port 320 may send or receive data between the outer terminal 300 and the memory reader 200 by connecting itself to the reader connector 280 of the memory card reader. Moreover, the memory card reader 200 may be incorporated in the outer terminal 30 in either embedded type or external type. And, the reader port 320 may be either embedded or external as the memory card reader.

The outer terminal 300 may be implemented in USB (Universal Serial Bus) Port (Not shown) other than the reader port 320. The outer terminal 300 may send or receive data to/from the memory card reader 200 by connecting the USB port to the reader connector 280.

Meanwhile, the reader controller 340 is a controller controlling transmission/receipt of data between the outer terminal and peripheral devices by sensing the peripheral devices connected to the reader port 320. According to the present invention, the reader controller 340 may acknowledge and control the memory card reader 200.

The terminal storing unit 380 may be implemented in hard disk. It may have internally OS (operating system) 360 and a client driver 370. The client driver 370 is provided by a manufacturing company of the memory card reader 200.

The outer terminal 300 may comprise a microprocessor (not shown). And, the microprocessor may control the outer terminal 300 on the whole according to both the OS 360 and the client driver 370 stored in the terminal storing unit 380.

Especially, the outer terminal 300 may display data outputted through the memory card reader 200 and send data to the memory card reader 200 for storing into the memory card 100, in case of a read/write mode.

Moreover, the outer terminal 300 may update the recovery program stored in the storing unit 240 by sending to the memory card reader 200 after connecting itself to homepage of the manufacturing company of the memory card reader 200 or receiving the updated information of the recovery program from relevant storage devices.

Therefore, the present invention may more effectively recover the memory card 100 in less time by updating the recovery program in the memory card reader 200 through the outer terminal 300.

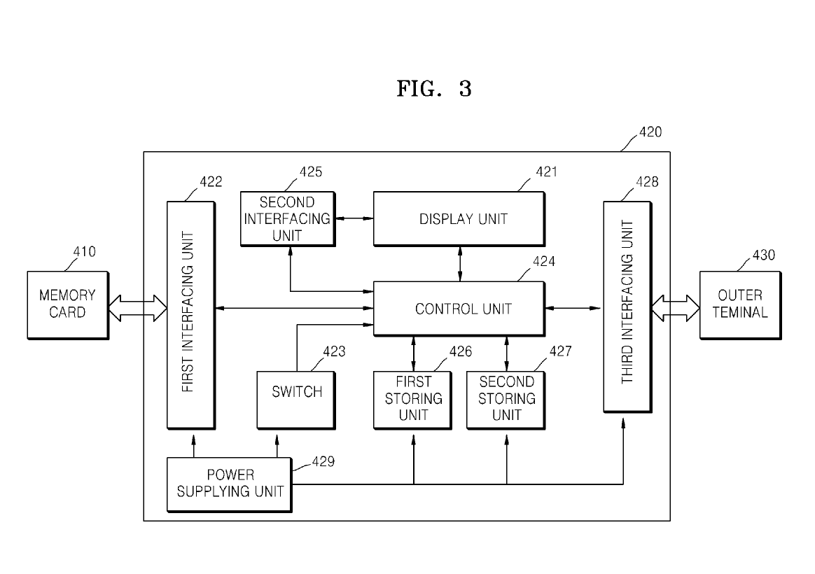

FIG. 3 is a block diagram partially illustrating a memory card reader according to still another exemplary embodiment of the present invention.

Referring to FIG. 3, a memory card reader 420 according to still another exemplary embodiment of the present invention may comprise a first interfacing unit 422, a first storing unit 426, a display unit 421 and a control unit 424. A memory card 410 may be inserted into the first interfacing unit 422. The first interfacing unit 422 may perform interfacing between the memory card 410 and the memory card reader 420. Data stored in the memory card 410 may transmit into the memory card reader 420 through interfacing of the first interfacing unit 422.

It is preferable that the first interfacing unit 422 may provide interfacing for a plurality of various memory cards. The first interfacing unit 422, for example, may provide interfacing for SD (Secure Digital), MMC (Multimedia Card) and CF (Compact Flash) memory cards. Namely, since the first interfacing unit 422 comprises a socket for both SD memory card and MMC memory card, and a slot for CF memory card, the memory card readers according to exemplary embodiments of the present invention may be compatible to various memory cards.

Referring to FIG. 3, the display unit 421 may display a file list corresponding to the data transmitted from the memory card 410 on the display screen. The file list may be enumerated by either file names or image form. The display unit 421 may provide preview function for any files displayed.

Moreover, the display unit 421 may display a file list for data recovered in case that any data impaired and/or deleted is recovered. Hereinafter, it will be illustrated about a method of displaying a file list for data recovered on a display screen after recovering any data impaired and/or deleted, in a memory card reader according to an exemplary embodiment of the present invention.

Users may select either a recovery mode or read/write mode for operating the memory card reader 420 according to still another exemplary embodiment of the present invention. For doing this, the memory card reader 420 of still another exemplary embodiment of the present invention may further comprise a switch 423 for selecting whether the control unit executes the recovery program.

The switch 423 may output either a read/write signal for read/write of memory card of one of general functions of memory card reader 420, or a recovery signal for recovering a memory card to be covered, based on user s selection. Therefore, as described above, the memory card reader 420 according to still another exemplary embodiment of the present invention may operate either a read/write mode or a recovery mode according to the output signal selectively outputted from the switch 423. More specifically, when the switch 423 is under a first state, it may output the read/write signal so as to perform the read/write function of the memory card reader 420. And, when the switch is under a second state, it may output the recovery signal so as to perform recovery for the data in the memory card reader 420.

Since the operation of read/write mode of the memory card reader 420 is obvious to those skilled in the art, the operation of the recovery mode will be illustrated hereinafter.

Referring to FIG. 3, the control unit 424 may execute the recovery program in the recovery mode. The recovery program may be stored in the first storing unit 426. Then, the first storing unit 426 may be Read Only Memory (ROM). The recovery program stored in the first storing unit 426 may recover a file to be recovered by loading itself to the control unit 424 in response to the recovery signal.

Below is illustrated about the algorithm using for recovery program. In case that a file is deleted under operating system using such a file system as FAT (File Allocate Table), the contents of the file is not deleted, but a file name corresponding to the file is just deleted in the FAT. Therefore, unless other files do store in physical address of the memory card storing physical files, a deleted file may be recovered by filling in the file name on the FAT. It may set for deleting file by deleting character corresponding to an arbitrary bit of the file name of a file to be deleted on the FAT.

It is preferable that the recovery program incorporated in the memory card reader 420 according to still another exemplary embodiment of the present invention may be compatible to a plurality of file systems having various versions. For example, it may be compatible to file system such as FAT 12, FAT 16 or FAT 32. Furthermore, the recovery program may update itself by using the outer terminal 430.

The file name of a file recovered like above may be set for other name than the original one. At this time, the control unit 424 may add an identifier identifying recovered file in the file name recovered. For example, in case that the file name of an original file is XX, the file name recovered may be differently set for REC_XX. Moreover, the control unit 424 may store files recovered in either other memory cards connected to the first interfacing unit 422 with different file names or the second storing unit 427. Therefore, users may easily distinguish files recovered from original ones by differently naming the file names of the files recovered.

The control unit 424 may store files recovered in other memory cards through the first interfacing unit 422. Meanwhile, in case of storing the files recovered in the second storing unit 427 of the memory card reader 420, the control unit 424 may set the files recovered so as to store in the second storing unit 427 as default. At this time, the second storing unit 427 may be RAM (Random Access Memory) or other non-volatile memories. The second storing unit 427 may perform functions of portable storage device in which receives and stores certain of data through terminals like computers. In order to perform the functions of the portable storage device, the control unit 424 may possess necessary programs. Since it is obvious to those skilled in the art, specific explanations will be omitted.

Moreover, users may use the original memory card since the data recovered stores in the second storing unit 427 rather than the original memory card in which impaired data exists, even though terminals such as computers are not connected to external.

As illustrated above, the display unit 421 may display a file list for the data recovered as well as another file list stored in the memory card. Thus, the memory card reader according to still another exemplary embodiment of the present invention may comprise the display unit; therefore, users may easily transmit files to external storage devices in which do not have display function. For example, the memory card reader according to still another exemplary embodiment of the present invention may transmit data (file) to external memories in which do not have display function, for example, USB memories, by selecting files to be transmitted of the file list displaying on a display screen.

Preferably, the memory card reader 420 may further comprise a second interfacing unit 425 for providing a user interface for the file displaying on the display screen as above. At this time, the user interface for the file displaying means interface performing operations such as display of file lists, either selection or cancellation of a specific file of the file list displaying, and scroll for the file list, etc. Especially, since the second interfacing unit 425 may comprise a button (for example, button for both position and selection) or jog shuttle which are all positioned on the memory card reader 420, users may easily manipulate the memory card reader 420, while selecting file.

Referring to FIG. 3, the memory card reader according to still another exemplary embodiment of the present invention may further comprises a power supplying unit 429 making powers necessary operation of the memory card reader itself. The power supplying unit 429 may comprise batteries or charging devices. The power supplying unit 429 of FIG. 1 is not depicted to connect itself to other components, but it may supply powers to every component of the memory card reader 420 according to still another exemplary embodiment of the present invention.

Preferably, the memory card reader 420 may further comprise a third interfacing unit 428 providing interfacing with an external terminal 430. The external terminal 430 may be multimedia players like PC, PDA, TV or DVD. The third interfacing unit 428 may be either USB interface or IEEE 1394 interface for connecting the memory card reader 420 to the external terminal 430. Meanwhile, The external terminal 430 may immediately recognize the memory card reader 420 as a moving disk by connecting the memory card reader 420 to the external terminal 430, therefore, it may be a lot more user-friendly.

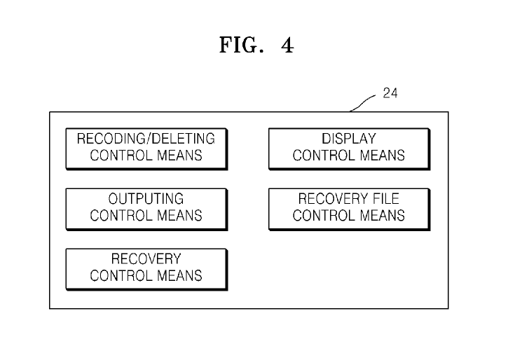

FIG. 4 is a block diagram illustrating the function of a control unit of FIG. 3.

Referring to FIGS. 3 and 4, the control unit 424 may control operations of the memory card reader 420. More specifically, it may control display (as a display control means) and execute recovery program (as a recovery control means). It may also generate and control file lists recovered (as a recovery file control means). Moreover, it may control data stored in the memory card 410, while outputting to the external terminal 430 (as a outputting control means), and control either data recording or data deleting into either memory card connecting to the first interfacing unit 422 or the second storing unit 427 (as a recording/deleting control means). Thus, the memory card reader according to still another exemplary embodiment of the present invention may recover data without external terminals by installing recovery program, and effectively recover data by providing Graphic User Interface (GUI) such as confirming and selecting files recovered on display screen.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims.

### INDUSTRIAL APPLICABILITY

This invention can be used in the field of memory and computer manufacture.

1. A memory card reader recovering memory card comprising:
an interfacing unit interfacing a memory card to be recovered;
a storing unit storing a recovery program for recovering the memory card;
a reader connector both transmitting and receiving data by connecting to a reader port of an outer terminal; and,
a control unit loading the recovery program stored in the storing unit, recovering data in the memory card received through the interfacing unit and outputting the data recovered to the reader connector.

2. A memory card reader recovering memory card of claim 1, wherein the storing unit is updated by receiving an updated recovery program from the outer terminal.

3. A memory card reader recovering data comprising:
an interfacing unit interfacing a memory card;
a switch selectively outputting a read/write signal or a recovery signal for either read/write or recovery of the memory card;
a storing unit storing a recovery program for recovering the memory card in response to the recovery signal of the switch;
a reader connector both transmitting and receiving data by connecting to a reader port of an outer terminal; and,
a control unit both sending data either read/written or recovered to the reader connector after performing either read/write of data or recovery by using the recovery program, into the memory card, in response to either the read/write signal or a recovery signal selectively outputted, and storing data outputted from the outer terminal into the memory card through the interfacing unit.

4. A memory card reader recovering data of claim 3,
wherein the storing unit is updated by receiving an updated recovery program from the outer terminal.

5. A memory card reader comprising:
a first interfacing unit interfacing with a memory card;
a first storing unit storing a recovery program for recovering any deleted or impaired data in the memory card;
a control unit executing the recovery program for the deleted or impaired data at a recovery mode: and,
a display unit displaying a file list of both data stored in the memory card and the data recovered on a display screen.

6. A memory card reader of claim 5 further comprises a second interfacing unit providing user interface for the file list displayed on the display screen.

7. A memory card reader of claim 5, wherein the display unit provides preview function for any selected files of the file list.

8. A memory card reader of claim 5,
wherein the recovery program is compatible to a plurality of file systems having various versions.

9. A memory card reader of claim 5, wherein the first interfacing unit provides interfacing for a plurality of various memory cards.

10. A memory card reader of claim 9, wherein the control unit stores files recovered in other memory card connecting to the first interfacing unit by mentioning other file names than original ones.

11. A memory card reader of claim 9, wherein the first interfacing unit provides interfacing for SD (Secure Digital), MMC (Multimedia Card) and CF (Compact Flash) memory cards.

12. A memory card reader of claim 5 further comprises a second storing unit, and the control unit stores files recovered in the second storing unit by mentioning other file names than original ones.

13. A memory card reader of claim 5 further comprises a power supplying unit making powers necessary operation of the memory card reader itself.

14. A memory card reader of claim 5 further comprises a third interfacing unit providing interfacing with an outer terminal.

15. A memory card reader of claim 5 further comprises a switch for selecting whether entering to the recovery mode.
